(19) United States
(12) Patent Application Publication
(10) Pub. No.: US 2013/0285834 A1
(43) Pub. Date: Oct. 31, 2013

(54) Instantaneous Telemetry from the Utility Revenue Meter by use of the Pulse Outputs or Optical Reader

(71) Applicants: Stephen Sellers, Lexington, MA (US); Peter Friedland, Mansfield Center, CT (US); Denise L Wiedl, Buffalo, NY (US); Paul Lindenfelzer, Tyngsboro, MA (US)

(72) Inventors: Stephen Sellers, Lexington, MA (US); Peter Friedland, Mansfield Center, CT (US); Denise L Wiedl, Buffalo, NY (US); Paul Lindenfelzer, Tyngsboro, MA (US)

(21) Appl. No.: 13/871,284

(22) Filed: Apr. 26, 2013

Related U.S. Application Data
(60) Provisional application No. 61/639,236, filed on Apr. 27, 2012.

(51) Int. Cl. G01D 4/00

(52) U.S. Cl. CPC G01D 4/002
USPC 340/870.02

(57) ABSTRACT

The invention comprises a method for obtaining accurate, instantaneous electric consumption data for telemetry purposes from the consumer's utility revenue meter. Heretofore, methods for obtaining high frequency telemetry have been limited to specialized devices which are not based on the utility revenue meter, or are unable to meet the temporal requirements of instantaneous telemetry. The invented method specifically uses external outputs of the utility revenue meter, the pulse outputs or optical reader, acquires and transmits high frequency telemetry in less than 30 seconds inclusive down to 1 second.

It is also significant that the invention considers the timing of meter data reads. Other approaches to reading the utility revenue meter focus on pulse counting or use of a predetermined time interval. In the current embodiment of the invention, the device measures the timing of each pulse which led to accuracy within a few seconds.

This application claims priority of provisional application No. 61/639,236 filed on Apr. 27, 2012 with confirmation number 5647.

### RELATED APPLICATION

Pertains to the provisional patent application filed on Apr. 27, 2012 with Application No. 61/639,236 and Confirmation Number 5647.

### BACKGROUND OF THE INVENTION

Energy market programs, intended to improve reliability of electricity on the grid, are run by the wholesale markets and are increasingly being opened by the regional authorities to accommodate commercial, industrial and residential consumers. In order to participate in these wholesale markets, the consumer must obtain acceptable telemetered electrical measurements which has proven to be a barrier to potential participants in these programs. Up to now, the ability to collect and transmit the revenue meter data at a timescale of less than 1 minute has been limited to those systems available to electric utilities and generators but unavailable to commercial and residential consumers due to the high cost and required infrastructure.

Traditional generation plants provide power to the electric grid and in turn the grid operators need to have visibility into the power plant meter data on a timescale of every few seconds. Therefore those plants have metering and telemetry systems installed to provide the necessary level of visibility to grid managers. One common telemetry system employs the following method with a series of devices: a utility generation meter, access to the meter's data registry through an internal serial port, routing of data to a remote terminal unit (RTU) and introduction of the data into a supervisory control and data acquisition (SCADA) system. Installation of a telemetry system of this type can be performed only by professional contractors in the power generation field.

Although telemetry devices based on generator meters are commercially available, they are not readily accessible to consumers. The obstacles to obtaining these generator telemetry systems include, but are not limited to, the prohibitively high costs of installation and device components per site. These fixed costs are economical for a large 100 megawatt generator, but are prohibitive for customer sites which are typically smaller and can be 1 megawatt or less. Additionally, these generator SCADA systems are designed to interface with the specialized generator meter which measures energy output, rather than energy consumption per customer, requiring additional modifications in order to make an already cost-prohibitive generator SCADA system to work for a customer site.

### Shortcomings of Existing Telemetry Methods

Certain energy grids, such as the PJM Interconnection, have enabled consumers to participant in wholesale programs requiring instantaneous telemetry (within seconds) based on a device that is independent of the utility revenue meter. Although these independent telemetry devices can transmit energy measures every few seconds, they are not sourced from the utility's revenue meter.

The utility's revenue meter is used for settlement of a consumer's utility bill on the retail level, determining the payment that the consumer makes to the utility. In contrast, the telemetry data is used for settlement of a consumer's participation in the wholesale market. The consumer is paid monies for wholesale service and, in turn, the wholesale market collects the funds by billing the utility. Using two different sources for settlement, as allowed in the PJM market, creates the potential for “missing money” as the consumer pays for retail utility service according to the revenue meter, whereas the utility is paying the consumer for a wholesale market service based on separate telemetry data.

The invention uses the same source for settlements at retail and wholesale levels, thereby reducing the possibility of financial discrepancy.

### Shortcomings of Existing Methods for Reading the Utility Revenue Meter

The most common utility revenue meters for commercial, industrial and residential electrical consumers provide standard interface ports. The usual options for retrieving meter data are internal serial ports, external optical readers and pulse outputs. The devices currently available in the market can be grouped broadly in two categories: (a) automatic meter reading (AMR) and smart meter upgrades (AMI) that use an internal serial port, and (b) pulse data loggers that use the pulse outputs for collecting and storing histories of usage data.

### AMR and AMI Card Add-Ons

Much of the development in the end-use customer telemetry has focused on the internal serial ports, (i.e. the AMR and AMI cards) as these provide direct access to the utility meter's data registry. A review of the commercially available AMR and AMI products determined that none of these add-ons supplied telemetry at the frequency of a few seconds. The reason is due to the design and intended purpose of these devices. While the meter registry can be configured to sample at a rate as often as once every 4 seconds, the collected data is then transmitted at a much longer timeframe (e.g. every 15 minutes, hourly, etc). The 15-minute or hourly data is then transmitted to the utility for the purpose of utility revenue settlements which are based on the longer timeframes of 15-30 minute demand readings and hourly interval data.

Modifying the more prolonged periodicity to furnish instantaneous telemetry, every few seconds, is not feasible with these devices. Because the design is intended to publish meter data every 15 minutes or more, they rely on power supplied by the utility meter itself (a super capacitor). This power supply is not sufficient to publish data more frequently as needed for telemetry every few seconds.

Additionally, AMI/AMR devices are limited in their ability to transmit this data off the customer's site. Common means of communication are radio wave transmitters, cellular networks, or programmable logic controllers (PLCs) over power lines. The use of radio transmitters and PLC methods have both declined in popularity due to issues with security and signal noise, respectively. Cellular network communication, in contrast, has gained in popularity but the cellular service is costly due to bandwidth requirements of the continuous (every few seconds) data feed. This cost escalation is in addition to the propriety software used by the AMR/AMI cards in order to access the meter's data registry.

In brief, even though the telemetry trend in the end-use customer sector is moving towards faster measurements, the commercially available products are not designed to fulfill the needs of telemetry from an end-use customer site in a manner which is both high resolution (every few seconds) and sourced from the utility meter.

### Pulse Outputs and Data Loggers

Pulse outputs are a type of external meter interface that is accessible and useful for custom applications. Meter pulses are on/off (1 or 0) values that are programmed to occur at a set number of energy units (e.g., 1 pulse per 10 kWh). Pulse outputs may come standard with the meter or they can be added by the meter owner without compromising the integrity of the utility revenue meter. (The AMI and AMR cards referred to earlier, which use an internal serial interface, have to undergo strict testing requirements by the utility and/or the state regulatory body.) In short, pulse outputs offer the possibility of a secure and straightforward way to make a data stream of energy values available for third party applications.

There are several types of commercially available devices that use pulse output data, the most common being data loggers. However, these loggers are designed and intended to provide log files of accumulated readings over 1 minute or more. Consequently, attempts to use these loggers for a shorter time period, such as a few seconds, proved infeasible as explained forthwith.

Data loggers generally function as follows: they count incoming pulses into the logger's registry, sample the logger registry at a predetermined rate, integrate over a timescale (one minute or longer), store in file format (e.g. comma separated values), then transmit over the Internet at a specified frequency. For real-time telemetry, these loggers are limited by their design and intended purpose. For example, many loggers are designed to integrate over 1 minute or longer, with a pre-programmed data sampling rate to support this longer time interval. By simply modifying the integration time, (for example, from 1 minute down to 6 seconds), the readings become unreliable because the pre-programmed logger registry sampling rate is too low. In one test it was found that the result was a 6 second integrated value based on too few data points, making the “forced” 6 second value highly inaccurate. If the rate of the incoming pulses was 3.5 pulses per 6 seconds, then this “forced” 6 second value would be alternating in the pulse counts between 3 pulses and 4 pulses, leading to large swings in the calculated kWh value.

A few loggers are capable of providing a raw pulse count based upon an “instantaneous rate” of the incoming pulse train. However, these instantaneous rates are not able to handle a fast pulse train—that is, a pulse train with a sufficient number of pulses as necessary to provide the datapoints needed for 6 second telemetry—without incurring a high number of uncounted or skipped pulses. For example, there was a single product which measured the time it took for 10 pulses to be counted in an “instantaneous rate.” For 6-second telemetry the pulse train had to be fast enough to produce 10 pulses in under 6 seconds, yet the high number of skipped pulse counts rendered this time measurement highly inaccurate and unable to provide instantaneous telemetry data. The limitation occurs because the “instantaneous rate” is based on counting of completed pulses, rather than the timing of when each new pulse occurs.

In an attempt to overcome this design limitation of erroneous pulse counts, one may install a “high pulse” add-on module in series with the logger in order to count faster (and therefore, more) pulses. The high pulse module is able to receive incoming pulse trains with frequencies faster than the logger itself, but it also produced a high error rate in the instantaneous counts. This error rate is not problematic when the add-on module is used as intended, in series with a logger, as the error rate (+/−error) is averaged out when the logger integrates over 1 minute or longer, but it renders this approach unproductive for instantaneous telemetry at every few seconds.

In conclusion, a survey of the commercial market and trials performed with low-cost, commercially available products (generator metering and SCADA systems, pulse data loggers, and high pulse add-on modules) conclusively determined that none were capable of accurately acquiring and transmitting utility revenue meter data at the instantaneous telemetry rates required by emerging energy grid programs.

### SUMMARY OF THE INVENTION

The present invention uses nonintrusive techniques sourced at the utility revenue meter in order to provide instantaneous telemetry (every few seconds) at high resolution. The method can use either the pulse outputs or the optical reader from the existent utility revenue meter. The pulse output train from the utility meter is specifically handled to extract information that is based on pulse timing, not pulse counting, which enables the production of instantaneous telemetry. Pulse timing can occur by means including, but not limited to, the time interval between pulses or timestamping each pulse.

The method is distinct in that it does not require pulse counting and therefore is not impacted by the limitations of counting each pulse in a fast pulse train, or in a shorter time interval, as necessary for instantaneous telemetry. The commercially-available devices function by counting, where counting is accomplished by summing the number of pulses or the reliance upon detecting each pulse in order to obtain the value (e.g. value per each 10 pulses). These devices either count the total number of pulses in a static time window, (such as the dubious attempts to count 3.5 pulses every 6 seconds resulting in the alternating counts of 3 or 4), or rely upon the ability to count each pulse in a fast pulse train (as required by the “instantaneous rate” per every 10 pulses counted).

The invented approach of pulse timing is a distinct method that reads the time that the pulse arrived in order to consider pattern recognition or fractional pulses, (as in the case of detecting a fractional 3.5 pulses), or alternatively to measure the time interval that occurs between the pulses (3.5 pulses in 6 seconds will be equivalent to 1,714,286 microseconds between each pulse). Comparisons of pulse times may include the integration between two detected pulses, as the integration is the time unit in microseconds. However, the pulse timing does not have the strict requirement of detecting each pulse in a series in order to obtain an accurate value.

Skipped pulses are less of a concern with pulse timing, as the invented method produces multiple readings within the intervals needed for instantaneous telemetry. In the given example of 3.5 pulses in the 6 second telemetry interval, there would be at least three separate microsecond values that makes any skipped pulses evident by a clear doubling in one of these microsecond values. By comparison, the previous methods produced only a single value during this telemetry interval. This single value, combined with a high error rate when attempting to count each pulse, rendered the previous methods unable to perform instantaneous telemetry.

For the pulse timing approach it is useful to record the precise times as accurately as possible. It is not necessary at this point to use calendar time; the internal clock time of the recording device will suffice because the tempo and rhythm of the pulses is the essential feature. Experience has shown that the best feature of the pulse to time is its trailing edge because the return to zero voltage is an event that can be accurately recognized. Collecting such data requires running a program with interrupts. These can be either hardware or software interrupts. It has been shown that hardware interrupts are more accurate.

In one implementation of this method, a commodity grade microprocessor was programmed to detect and time pulse edges. To improve the accuracy of this method, the meter was re-configured to emit more frequent pulses subject to the limitations of the meter or, equivalently, to have each pulse represent a smaller quantum of energy. This entails coordination with the meter authority. In the pilot project, a fast pulse train at 12 Hz or more (i.e. 12 pulses or more per second) was effected and this sufficed to provide accuracy within 6 seconds. Although a pulse train of such high Hz is rarely seen in the consumer sector, (as pulse data loggers function on a longer timescale), our tests show it is both feasible and achievable.

These higher rate pulses are then sent to the device which performs the next steps in the method—the accurate reading of the pulses. To obtain accurate power readings it is essential that the timing of the pulses be measured rather than simply counting them for a time interval. Timing is accomplished by using either the hardware or software interrupt capability of the meter data device. A standard microprocessor board is capable of handling the anticipated speed and variability of the incoming pulse train. Since load curtailment is one of the programs to which the methodology may be applied, electricity load values must be accurate when the incoming pulses are relatively high at 15 Hz (i.e. a 15 MW baseline load) as well as at slower pulse trains (e.g. a 3 Hz incoming pulse train) when load is reduced.

Processing of the data on the communication device is minimized in order to expedite performance and to save power. Once electrical consumption readings are acquired, they are timestamped and transmitted directly to the data server's portal. Secure shell tunneling (SSH) ensures secure network transmission and may be implemented over Ethernet and/or cellular transmitter. Employing both mechanisms jointly provides redundancy and a more robust system.

At the data server, software routines compute the time intervals between pulses from the relative timestamps already paired with them, and perform further analysis which may include Fast Fourier Transform (FFT) or wavelets. Wavelets have the advantage of having both frequency and time domain information. Well-known mathematical techniques are used to obtain further accuracy and quality information of the data. This would not be possible if mere pulse counts were associated with the meter data instead of accurate timestamps; that is to say, precision is lost for want of the timing information. The processor formats the data for transmission by the router including applicable quality flags, as configured in accordance with the telemetry requirements of the pertinent energy program.

A schematic representation of the method (FIG. 1) shows instantaneous reading of consumption [101] from the electric meter and transmission to the data server [102]. The shaded box contains important elements of this provisional patent application including data acquisition from the utility revenue meter [103], calculation of raw telemetry values at the local processor [104] and instantaneous transmission over secure http and cellular [106] channels. Note that transmission may occur by several channels, such as over the Internet (e.g. secure http) and cellular; one is sufficient but multiple channels provide backup. One embodiment of this novel method of instantaneous telemetry sourced at the utility revenue meter utilizes the reading of pulse timing as shown in [107] of FIG. 1, with more details discussed later. The method also includes a log history of the readings [108] to provide recovery of data in case of communication failure, although this is not a necessary component.

### BRIEF DESCRIPTION OF THE DRAWINGS

FIG. 1 is one embodiment of the Instantaneous Telemetry Device with Pulse Reading of the Utility Revenue Meter.

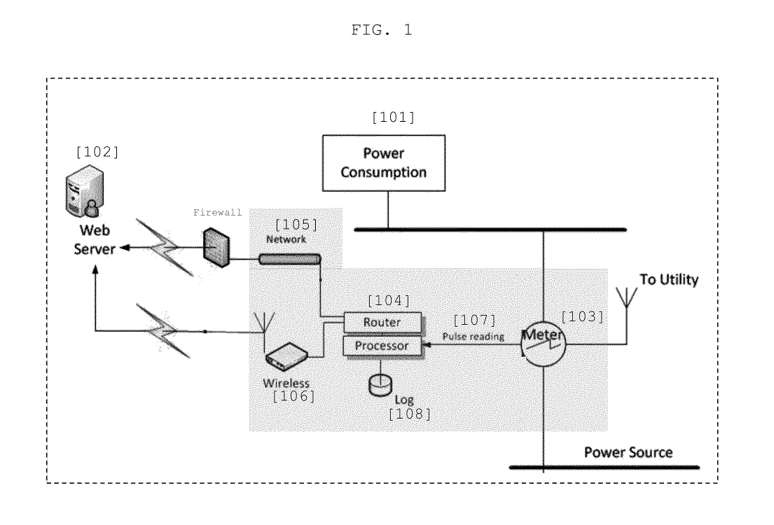

FIG. 2 is an example of Pulse Counting compared to Pulse Timing over 1 second.

FIG. 3 is an alternative design for the Instantaneous Telemetry Device which utilizes the Optical Reading of the Utility Revenue Meter.

### DETAILED DESCRIPTION OF ONE EMBODIMENT OF THE INVENTION

The invented method has been implemented at a pilot site for use in the New York State electric grid overseen by the New York Independent System Operator (NYISO). The NYISO has recently introduced a program allowing customers to participate in certain energy markets, one condition of which is that the customer provides instantaneous telemetry of load as sourced from a revenue grade meter. Below is a detailed description of how the method of the present invention was employed to enable one customer to achieve 6-second telemetry.

To obtain the best resolution possible from the existing customer meter, it was configured for the highest number of pulses possible unobtrusively from the meter's pulse outputs. In preparation, the calculation was made for the maximum pulse output factor possible for the meter and the corresponding KYZ (pulse output) board contained within the meter. The pulse output board had a ceiling value of 15 pulses per second (15 Hz), corresponding to hardware limitations of the meter itself. The meter was reprogrammed by the utility (the meter owner) to produce 1 pulse per 1 kWh and 1 pulse per 1 kVArh through the pulse outputs. For the customer, who consumed a maximum of 50 MWs per hour, the conversion worked out to be a maximum of approximately 13.8 pulses per second—within the limits of the meter and KYZ hardware.

With the meter reconfigured for a fast output pulse train, the next step was to ensure that the trailing edges of the pulses could be accurately timestamped (in tests, timestamping was able to occur within 4 microseconds). The power readings calculated from the pulses were later calibrated in the lab by comparing known, simulated load values to the calculated readings.

The pulse timer and power level calculator need to function accurately at a wide range of pulse frequencies. For example, the customer might reduce load from 48 MWh (48000 kWh) down to 3 MWh (3000 kWh). Therefore, a pulse detector and error correction system was needed that would accurately detect a pulse train coming in at a range from 0.8 Hz up to 14 Hz. As discussed above, the commercially-available devices had limited accuracy due to the reliance upon a counting approach that was insufficient for producing instantaneous telemetry from a high frequency pulse train.

The invented solution applied in this embodiment was to treat the train of discrete pulses as a higher order polynomial (a high frequency wave) with the rate of change in the wave, the derivative or slope, being used as a method to identify the pulse edge. By this approach, the detection of discrete pulses is based upon any one of the many derivatives corresponding to the points along the downward slope of the wave. This approach significantly increases the probability of detecting the discrete pulses and resulted in minimal skipped pulses.

The next step was to create a value that is representative of the pulse train, which the invention treats as a time value that includes, but is not limited to, the integration into microsecond values, recording the timestamps corresponding to the detected pulse edges, or predictive methods to determine that a fractional pulse has occurred within the allotted time. However, there is not a value corresponding to a count nor is there a reliance on counting a short series of pulses. as this counting approach is limited based upon the necessity of detecting each pulse in a series.

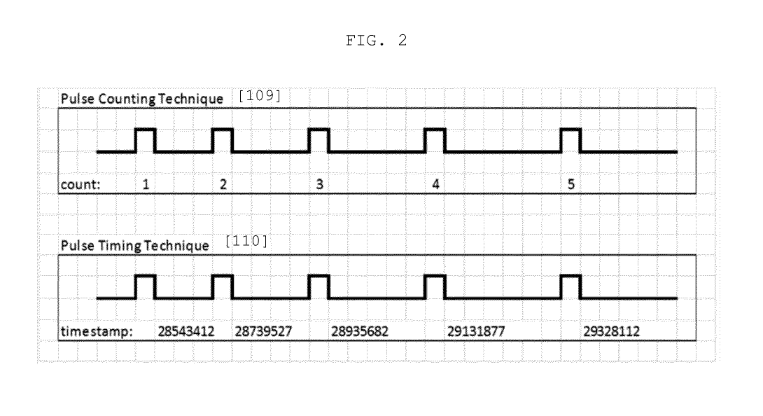

By way of example but not limitation, FIG. 2 compares the pulse counting technique of the prior art [109] to the pulse timing technique of the present invention [110].

Using the pulse counting technique of the prior art, 5 pulses were counted during the 1 second sampling interval, and thus a 5 Hz signal, converted to an instantaneous reading of 18,000 kW (that is, 5 kWh/sec×3,600 seconds).

With the pulse timing technique of the present invention, there is a detector that records accumulated microseconds at the trailing edge of each pulse. The number of microseconds between the first two pulses is 196,115 (that is, 28,739,527−28,543,412) and thus 18,357 kW (that is, 1 kWh=0.196115 seconds×3,600 seconds/hour). The difference between the two techniques is a few hundred kW in a fraction of a second. For the pulse timing technique, one could further refine the telemetered value by averaging over the sampling period or taking into account the evident trend of lengthening time between pulses.

After the timestamping of pulses, two different methods for conversion to units (pulse frequencies back into kWh) and communications were tried: (a) either convert the pulse data back into units (e.g. kWh) before sending it to the remote server or (b) transmit the raw pulse timings out to a server where the conversion would then take place. Both approaches performed adequately when tested; the latter approach was selected because it allowed easier implementation of a steady communication stream, greater precision and minimized computation and power consumption (less than 5 watts) on the integrated device.

As noted previously, most meters provide two pulse streams: one for measuring kWh pulses and the other for measuring kVArh pulses. Both streams are amenable to the method described here; therefore, the power factor can be obtained in real time. Since reactive power increases the cost of electrical power and does nothing useful, many industrial power consumers install devices to improve the power factor. High frequency power readings with power factor can be used to directly control such devices in real time, with cost savings to the customer. This is another use of the method and device described herein, which has potential commercial value.

Redundant communication channels were employed for enhanced reliability: the primary channel is a secure virtual network on the customer's local area network over Internet to the data server in this implementation; the backup channel was cellular transmission from the router.

Having established accurate reading of the pulses, software on the data server was enabled to assess data quality, format the data as required by the regional authority and transmit at the scheduled 6-second frequency.

### Alternative Techniques for Pulse Timing

In the present embodiment of the novel method of measuring the pulse timing from a utility revenue meter, the measurement utilizes the time interval between pulses (in microseconds) as shown in FIG. 2. Alternative methods considered as part of the novel method include using pattern recognition to get fractional pulses (representative of pulse timing), or the direct timestamping of pulse edges.

### Alternative Technique for Meter Data Acquisition

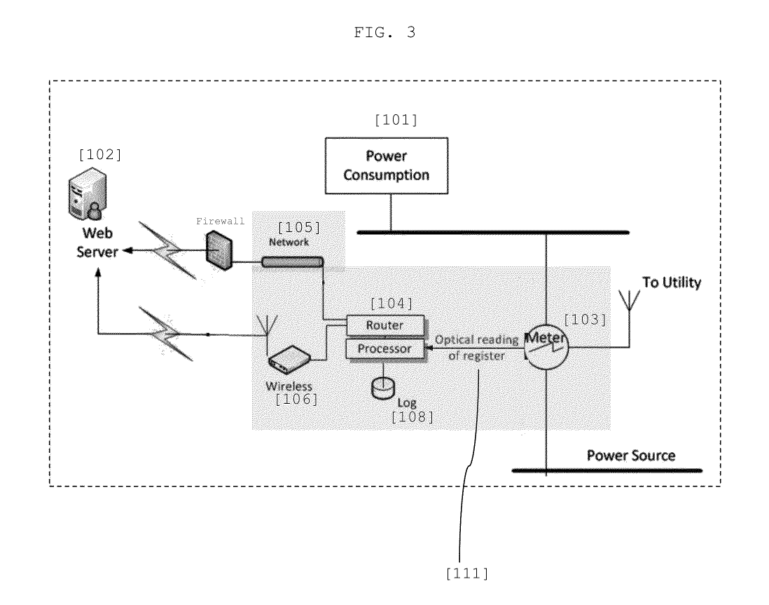

An alternative technique for acquiring meter data from a utility revenue meter for purpose of instantaneous telemetry, is the use of an optical reader (see FIG. 3 [111]). Many commercial electric meters are equipped with an optical port that provides access to the meter's internal registers. The reader adheres magnetically to the port so it is nonintrusive; however, installation does generally require approval from the meter owner (usually the utility). As such this novel method was built and tested, but not elected for our current embodiment of this invention.

Advantages are that optical reader uses standard communications protocols—RS232 or USB 2.0—and connection by fiber optic cable, which is impervious to background electrical noise.

Knowledge of the content and format of the data in the meter's register can be obtained from the manufacturer's manuals or deduced by empirical testing.

1. A method of producing instantaneous telemetry sourced from the utility's revenue meter, as defined as meter data values which are obtained and transmitted off the local site within less than 30 seconds, and inclusive down to 1 second, of the electric consumption being measured by the utility meter.

2. A method of obtaining meter data values from the utility's revenue meter through the pulse outputs, specifically for the purpose of instantaneous telemetry.

3. A method of obtaining meter data values from the utility's revenue meter through the optical reader, specifically for the purpose of instantaneous telemetry.

4. A method of handling the pulse output from an electrical consumption metering device by pulse timing, rather than counting of completed pulses within a period. (“Counting” is defined as an attempt to sum the number of pulses, or the reliance upon detecting each pulse in a series in order to obtain the value (e.g. instantaneous rate per each 10 pulses).) The invented pulse timing method includes, but is not limited to, time intervals between pulses (time for each new pulse to occur), pattern recognition of pulse timing and/or use of fractional pulses, and timestamping of pulse edges.

5. A method of treating the pulse outputs from an electrical consumption metering device as a higher order polynomial with the discrete pulses being detected based upon the derivate or slope along the curve.

6. A single embodiment of this method using a device capable of measuring the pulse timing from a utility revenue meter in order to transmit instantaneous telemetry values. This embodiment includes a transmission system to relay the telemetry data via Internet, cellular, or both.
